(19) United States
(12) Patent Application Publication
(10) Pub. No.: US 2019/0165576 A1
(43) Pub. Date: May 30, 2019

(54) SELF-ORGANIZING VARIABLE VOLTAGE DIRECT CURRENT ELECTRIC GRID

(71) Applicant: Mark Stephen Dudzinski, Alpharetta, GA (US)

(72) Inventor: Mark Stephen Dudzinski, Alpharetta, GA (US)

(21) Appl. No.: 16/202,650

(22) Filed: Nov. 28, 2018

Related U.S. Application Data
(60) Provisional application No. 62/591,746, filed on Nov. 28, 2017.

(51) Int. Cl. H02J 1/10; H02J 3/38; H02J 4/00

(52) U.S. Cl. CPC H02J 1/102; H02J 4/00; H02J 3/383; H02J 3/386

(57) ABSTRACT

A system to provide variable voltage self-organizing direct current (DC). The system includes a variable voltage electric grid having one or more DC loads and one or more DC power sources electrically connected to the variable voltage DC electric grid. At least one node includes at least one DC to DC converter electrically connecting the one or more DC loads with the one or more DC power sources of the variable voltage DC electric grid. The at least one node manages and monitors its electric connection to the variable voltage DC electric grid.

### CROSS-REFERENCE TO RELATED APPLICATION

This application claims the benefit of priority of U.S. provisional application No. 62/591,746, filed Nov. 28, 2017, the contents of which are herein incorporated by reference.

### BACKGROUND OF THE INVENTION

The present invention relates to an electric grid and, more particularly, to a variable voltage direct current (DC) grid.

The design and construction of an electric grid takes significant planning. Electric grids that interconnect generation and loads use alternating current (AC) technology. This technology is used to interconnect geographically distributed loads and generation. AC grids can spread over large geographies. The DC grids that exist are found predominately inside of buildings. They are not used to interconnect loads that are geographically dispersed.

There are many different sizes of AC Grids that exist today. By definition they include electric generators that generate electricity, power lines to distribute the electricity from the electric generators to consumers, and consumers who use the electricity. In some cases, there is additional generation at the consumer. In very few cases there is electric storage in the system.

The electric grids are characterized by their distribution over a large area. The smallest are typically the size of a small village, town or campus. Generally, they are larger than a city. They can be very large encompassing whole countries and/or parts of continents.

All of the AC Grids require the use of a grid controller. They are commonly referred to as Energy Management Systems (EMS's). The grid controller is responsible for several functions, such as matching the generation to the load, managing the system voltage, managing the system frequency, and managing production of VARS.

Matching the generation to the load is required since the generation on the system must exactly match the load in the system. In the few cases where electric storage is in place, the storage must also be managed. It is managed as a load when the storage is being charged and as a generator when it is being discharged. The controller may include economic and time-based analysis to decide when to charge storage on the system and when to discharge the storage on the system.

Managing the system voltage is required for several reasons. Generators must be added to the grid during times of high load and must be removed from the grid for maintenance or when a power plant is inoperable. The voltage must also be maintained within certain narrow plus and minus limits for proper operation of the connected loads. Too high a voltage would cause over voltage in the loads leading to failure. Too low a voltage has two problems. Some loads will not operate when the voltage is too low. Other loads could draw too much current resulting on overheating.

Managing the system frequency is required for several reasons. Connected loads such as radios, televisions, computers, motor drives, micro wave ovens and other electronics are designed to operate within a certain frequency range. Frequencies that are too low or too high can result in failure of the equipment. Other loads such as AC motors operate in synchronism with the AC frequency. AC motors connected to the system would run too fast if the system frequency is too high and too slow if the system frequency is too low. In addition, connected generators are designed to operate within a very tight frequency tolerance. If the frequency is not controlled within a specified range, the connected generators may lose their ability to run synchronously with the grid resulting in voltage collapse and system blackouts.

Managing the production of VARS is required to provide the magnetizing current for AC motors, transformers and other magnetic devices that are connected to the power system. If there are insufficient VARS produced, the voltage on the system sags which may result in brownouts or system wide blackouts.

To accomplish the above, the systems usually have sophisticated systems for monitoring voltage, current, and frequency in different parts of the system. Models are used to simulate the system, which allows the operator to understand the current status and help manage the system. Schedulers help manage the dispatch of generation. Controls are used to manage the way the system is connected in order to isolate problems, reconfigure the system in the event of a localized failure, and to shed load if the available generation capacity is insufficient to meet the load requirements.

As can be seen, there is a need for a self-organizing, variable voltage DC electric grid that does not require voltage regulation, frequency regulation, or VAR generation.

### SUMMARY OF THE INVENTION

In one aspect of the present invention, a node comprises: at least one direct current (DC) to DC converter configured to receive power from an electric grid, provide power to a load, and provide power to the electric grid; a sensor configured to measure a voltage of the electric grid; and a processor electrically coupled to the sensor and the at least one DC to DC converter, wherein the processor determines the voltage of the electric grid via the sensor; enables the at least one DC to DC converter to receive power from the electric grid if the load needs power, and enables the at least one DC to DC converter to provide power to the electric grid if the node has excess power.

In another aspect of the present invention, a system to provide variable voltage self-organizing direct current (DC) comprises: a variable voltage DC electric grid having one or more DC loads and one or more DC power sources electrically connected to the variable voltage DC electric grid; at least one node comprising at least one DC to DC converter electrically connecting the one or more DC loads with the one or more DC power sources of the variable voltage DC electric grid, wherein the at least one node manages and monitors its electric connection to the variable voltage DC electric grid.

These and other features, aspects and advantages of the present invention will become better understood with reference to the following drawings, description and claims.

### BRIEF DESCRIPTION OF THE DRAWINGS

FIG. 1 is a schematic view of an electric grid of an embodiment of the present invention;

FIG. 2 is a schematic view of a node of an embodiment of the present invention;

FIG. 3 is a schematic view of a node of an embodiment of the present invention;

FIG. 4 is a schematic view of a node of an embodiment of the present invention;

FIG. 5 is a schematic view of a circuit board of a node of an embodiment of the present invention; and

FIG. 6 is a continuation of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a variable voltage DC electric grid. The variable voltage DC electric grid is a self-organizing electric grid that operates over a wide voltage range and does not require voltage regulation, frequency regulation, or VAR generation. Simple interconnection rules allow the grid to be built without custom engineering design and support. In addition, the grid auto restarts, without human intervention, if there is a blackout caused by no generation.

As mentioned above, previous grid designs require that the voltage on the grid is controlled within specified narrow limits, usually plus or minus 5%, which requires generation and/or load management. The electric grid of the present invention does not require that the voltage or frequency of the grid be managed within narrow limits. Due to the design of the present invention, the voltage can vary over very wide margins. For example, the voltage may drop by 75% or more without shutting down the grid of the present invention.

The present invention includes a design and method of use of a DC grid that includes generation, electric storage, and system loads without the use of a central controller and without the need for planning the electric distribution infrastructure. The present invention employs intelligent devices at the interconnection of the nodes in the DC grid. Algorithms are run in the intelligent nodes that allow the nodes to consume power from the grid or deliver power to the grid without communication to or management from a central control system. This is done in such a way that the grid remains stable and operational even if the connected generation is less than the system load. The system remains available even if the voltage collapses to zero intermittently or for considerable periods of time such as a day or week. Nodes including generation, storage and loads may be added to the system or removed from the system at any time without prior notice to any other node. The remaining nodes or added nodes join the self-organizing system without any negative system impact.

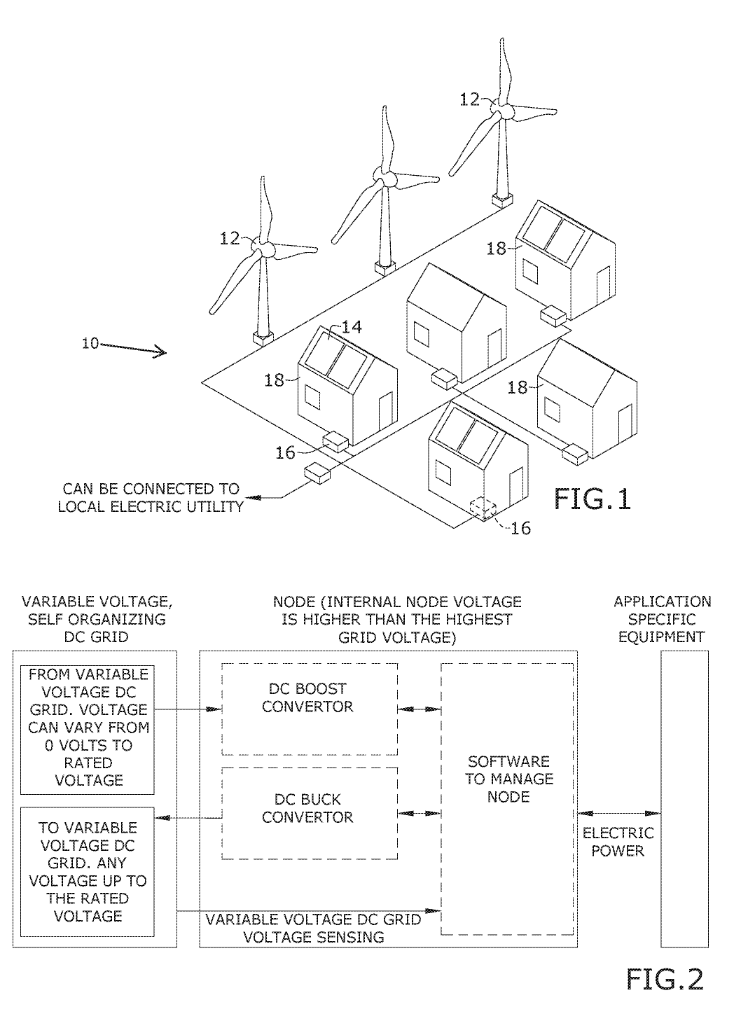

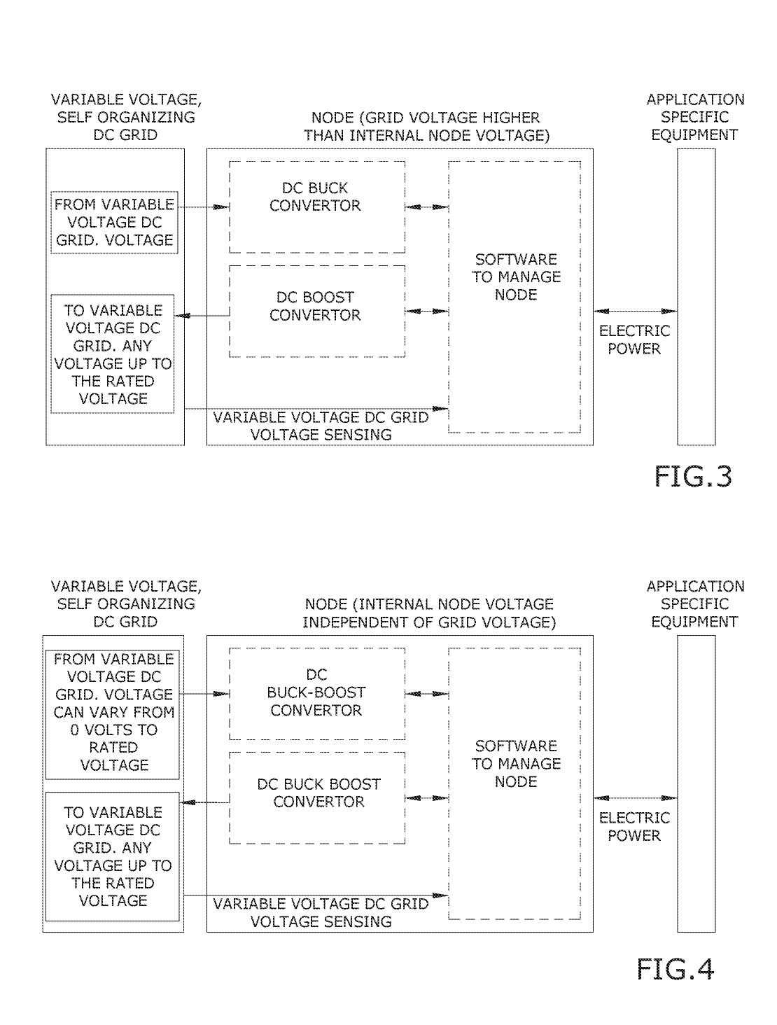

Referring to FIGS. 1 through 4, the present invention includes a system to provide variable voltage self-organizing direct current (DC). The system includes a variable voltage DC electric grid 10 having one or more DC loads 18 and one or more DC power sources 12, 14 electrically connected to the variable voltage DC electric grid 10. At least one node 16 includes at least one DC to DC converter electrically connecting the one or more DC loads 18 with the one or more DC power sources 12, 14 of the variable voltage DC electric grid 10. The at least one node 16 manages and monitors its electric connection to the variable voltage DC electric grid 10.

The present invention may include a plurality of nodes 16 each connected to loads 18 of houses or buildings. Each of the nodes 16 may include at least one direct current (DC) to DC converter configured to receive power from the electric grid 10, provide power to the load 18, and provide power to the electric grid 10. The nodes 16 may each further include a sensor and a computing system. The computing system includes a processor and a memory, with software loaded on the memory. The sensor is configured to measure a voltage and optionally a current of the electric grid 10. The computing system is electrically coupled to the sensor and the at least one DC to DC converter. The computing system determines the voltage and the current of the electric grid via the sensor, enables the at least one DC to DC converter to receive power from the electric grid 10 if the load 18 needs power, and enables the at least one DC to DC converter to provide power to the electric grid 10 if the node 16 has excess power.

In certain embodiments, the at least one DC to DC converter is a first converter configured to receiver power from the electric grid 10, and a second converter configured to provide power to the electric grid 10. In certain embodiments, the at least one DC to DC converter is a bi-directional converter configured to receiver power from the electric grid 10 and provide power to the electric grid 10. The convertors may be turned off so no power is supplied to or is taken from the electric grid 10. The system works with isolated and non-isolated DC to DC convertors.

The nodes 16 and the electric grid 10 may include multiple configurations. For example, an internal node voltage of the node 16 is higher than a highest grid voltage of the electric grid 10, an internal node voltage of the node 16 is lower than a highest grid voltage of the electric grid 10, or the internal node voltage of the node 16 is independent of the grid voltage. When internal node voltage of the node 16 is higher than the highest grid voltage of the electric grid 10, the first converter is a boost converter and the second converter is a buck converter. When the internal node voltage of the node 16 is lower than a highest grid voltage of the electric grid 10, the first converter is a buck converter and the second converter is a boost converter. When the internal node voltage of the node 16 is independent of the grid voltage, the node 16 includes a first bi-directional buck boost converter and a second bi-directional buck boost converter.

In certain embodiments, certain nodes 16 may only provide power. In such embodiments, only one single direction DC-DC convertor is utilized. Electric power is supplied from the power source 12, 14 to the node 16. The node 16 then provides power to the electric grid 16. The power source 12, 14 can be any type of generation, including but not limited to: PV Solar 14, thermal solar, wind turbines 12, and traditional fossil fuel generators/power plants. In certain embodiments, certain nodes 16 are only connected to a load 18 and only include one single direction DC-DC convertor. All of the nodes 16 may be interconnected by electrical cable forming the DC variable voltage grid 10. A minimum grid 10 can contain one generating node 16 and one load node 16 connected by cabling. A small grid 10 can contain several nodes 16 that can generate power and consume power. Larger girds 10 have nodes 16 that only generate power, only consume power and nodes 16 that can do both.

The present invention may be utilized as a low capital cost solution to providing electricity to people in the world who live by firelight. With this solution, the present invention may utilize solar, small wind, energy storage, thermal power generation, hydro and other power sources to provide low cost electricity to people who do not have access to the main AC grid. The present invention could also be used to improve the reliability of power delivery to people in the world who are connected to the main grid but have unreliable power.

With respect to the above description then, it is to be realized that the optimum dimensional relationships, to include variations in size, materials, shape, form, position, function, subsystems, components and manner of operation, assembly and use, are intended to be encompassed by the present disclosure.

It is contemplated herein that a variety of materials and configurations may be utilized to construct the variable voltage self-organizing DC electric grid that operates over a wide voltage range and does not require voltage regulation, frequency regulation, or VAR generation.

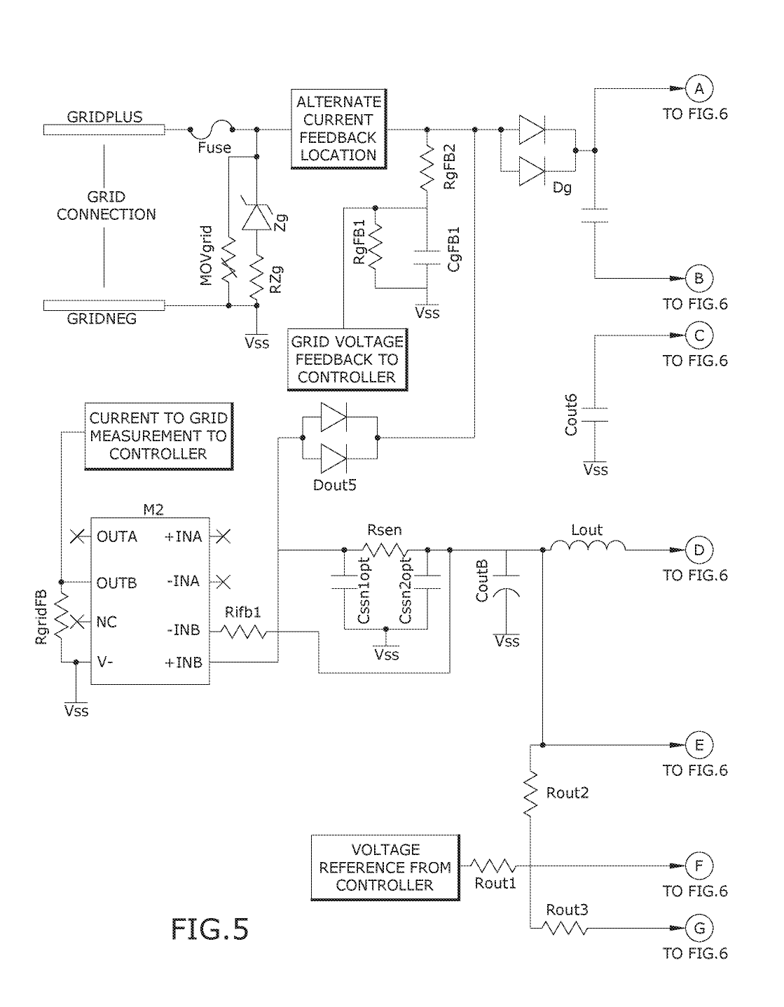

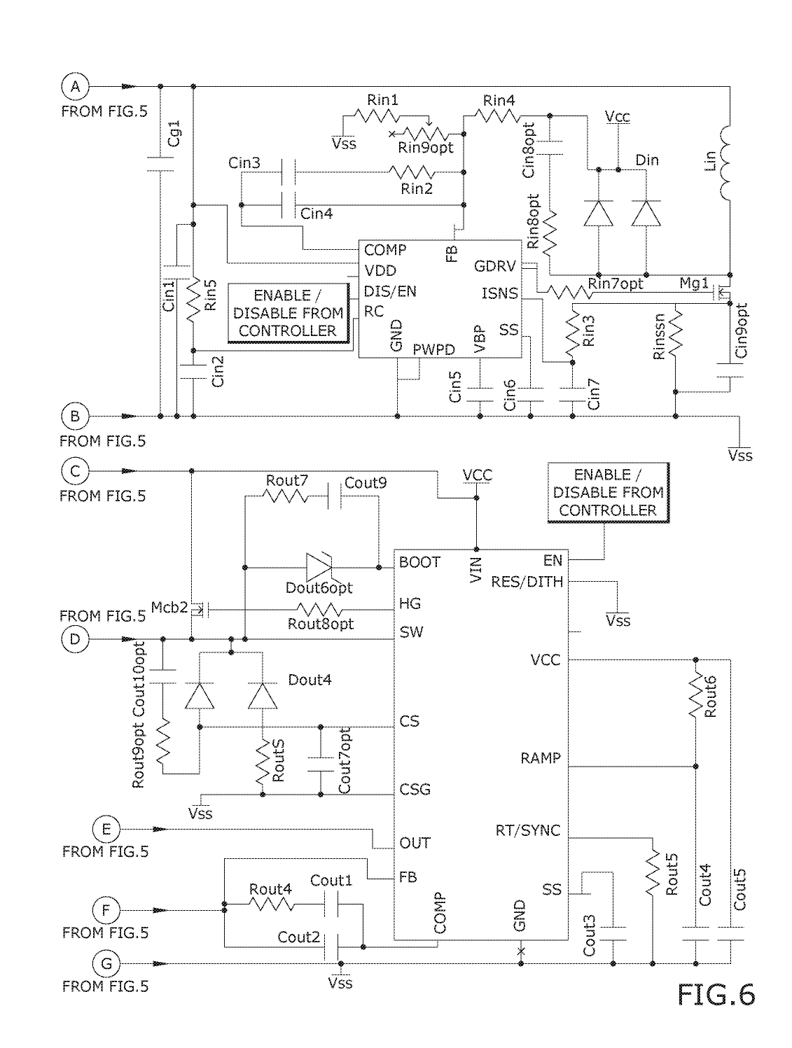

As illustrated in FIGS. 5 and 6, one or more DC-DC bidirectional converters or a first DC to DC converter and a second DC to DC converter may be configured on a circuit board comprised of resistors, capacitors, inductors, diodes, DC-DC converters, logic circuits, current sensors, microprocessor, controller (programmable), logic imbedded software, firmware, BIOS, application specific equipment, wire terminals (load and power/battery), and other like electrical or electronic components.

Moreover, the different deployable system may be configured in series, parallel, individually, grouped or in combination on the variable voltage self-organizing DC electric grid.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

What is claimed is:

1. A node comprising:
at least one direct current (DC) to DC converter configured to receive power from an electric grid, provide power to a load, and provide power to the electric grid;
a sensor configured to measure a voltage of the electric grid; and
a processor electrically coupled to the sensor and the at least one DC to DC converter, wherein the processor
determines the voltage of the electric grid via the sensor;
enables the at least one DC to DC converter to receive power from the electric grid if the load needs power, and
enables the at least one DC to DC converter to provide power to the electric grid if the node has excess power.

2. The node of claim 1, wherein the at least one DC to DC converter is a first converter configured to receiver power from the electric grid, and a second converter configured to provide power to the electric grid.

3. The node of claim 1, wherein the at least one DC to DC converter is a bi-directional converter.

4. The node of claim 2, wherein an internal node voltage of the node is higher than a highest grid voltage of the electric grid.

5. The node of claim 4, wherein the first converter is a boost converter and the second converter is a buck converter.

6. The node of claim 2, wherein an internal node voltage of the node is lower than a highest grid voltage of the electric grid.

7. The node of claim 6, wherein the first converter is a buck converter and the second converter is a boost converter.

8. The node of claim 1, wherein the at least one DC to DC converter comprises a first bi-directional buck boost converter and a second bi-directional buck boost converter.

9. The electric grid of claim 1, comprising a plurality of nodes, at least one DC power source, and the plurality of the loads electrically connected together.

10. A system to provide variable voltage self-organizing direct current (DC) comprising:
a variable voltage DC electric grid having one or more DC loads and one or more DC power sources electrically connected to the variable voltage DC electric grid;
at least one node comprising at least one DC to DC converter electrically connecting the one or more DC loads with the one or more DC power sources of the variable voltage DC electric grid, wherein
the at least one node manages and monitors its electric connection to the variable voltage DC electric grid.

11. The system of claim 10, wherein the at least one DC to DC converter comprises a first DC to DC converter and a second DC to DC converter, the first DC to DC converter electrically connects the one or more DC loads to the variable voltage DC electric grid and the second DC to DC converter electrically connects the one or more DC power sources to said variable voltage DC electric grid.

12. The system of claim 10, wherein each node further comprises:
a sensor configured to measure a voltage of the variable voltage DC electric grid; and
a processor electrically coupled to the sensor and the at least one DC to DC converter, wherein the processor
determines the voltage of the variable voltage DC electric grid via the sensor;
enables the at least one DC to DC converter to receive power from the variable voltage DC electric grid if the one or more DC load needs power, and
enables the at least one DC to DC converter to provide power to the variable voltage DC electric grid if the node has excess power.

13. The system of claim 10, wherein the power sources comprise at least one of a wind turbine, a solar panel, and a fossil fuel generator.

14. The node of claim 10, wherein the at least one DC to DC converter is a first converter configured to receiver power from the variable voltage DC electric grid, and a second converter configured to provide power to the variable voltage DC electric grid.

15. The node of claim 10, wherein the at least one DC to DC converter is a bi-directional converter.

16. The node of claim 14, wherein an internal node voltage of the node is higher than a highest grid voltage of the grid.

17. The node of claim 16, wherein the first converter is a boost converter and the second converter is a buck converter.

18. The node of claim 14, wherein an internal node voltage of the node is lower than a highest grid voltage of the grid.

19. The node of claim 18, wherein the first converter is a buck converter and the second converter is a boost converter.

20. The node of claim 10, wherein the at least one DC to DC converter comprises a first bi-directional buck boost converter and a second bi-directional buck boost converter.
